(19) United States
(12) Patent Application Publication
(10) Pub. No.: US 2022/0067171 A1
(43) Pub. Date: Mar. 3, 2022

(54) SYSTEMS AND METHODS FOR AUTOMATED ATTACK PLANNING, ANALYSIS, AND EVALUATION

(71) Applicants: KABUSHIKI KAISHA TOSHIBA, Tokyo (JP); Perspecta Labs Inc., Basking Ridge, NJ (US)

(72) Inventors: Fukutomo NAKANISHI, Sumida Tokyo (JP); Naoki OGURA, Yokohama Kanagawa (JP); Satoshi AOKI, Kawasaki Kanagawa (JP); Yoshikazu HANATANI, Komae Tokyo (JP); Jason YOUZWAK, Basking Ridge, NJ (US); Michael HYLKEMA, Basking Ridge, NJ (US); Subir DAS, Basking Ridge, NJ (US)

(73) Assignees: KABUSHIKI KAISHA TOSHIBA, Tokyo (JP); Perspecta Labs Inc., Basking Ridge, NJ (US)

(21) Appl. No.: 17/008,896

(22) Filed: Sep. 1, 2020

(51) Int. Cl. G06F 21/57

(52) U.S. Cl. CPC G06F 21/577; G06F 2221/034

(57) ABSTRACT

A control apparatus with automated test suites according to an embodiment includes capability information storage, and at least one hardware processor configured to function as an analyzer, an organizer, and an executor. The capability information storage stores therein a plurality of capabilities defining actions indicating attack methods. The analyzer parses at least one of network structure information of a system under test and vulnerability information of the system under test to extract the actions from the capabilities. The organizer generates an attack path through which an achieved state of an attack goal is reached by combining the actions extracted by the analyzer. The executor executes the actions included in the attack path.

### FIELD

Embodiments described herein relate generally to an automation in performing attack or penetration, planning and analysis and execution of such attacks using an automated test suite and a control apparatus that can be built using a computer program product.

### BACKGROUND

In recent years, there have been an increasing number of cyber-attacks against systems such as factories and power stations of industrial control systems that create significant damages to businesses and human sufferings. In order to determine the security posture of a system, a penetration test can be performed. Security flaws and weaknesses can then be remediated, resulting in a system that is more resistant to cyber-attacks. For critical systems, it is especially important to perform penetration tests frequently, addressing the latest threats with each engagement. Traditional penetration testing has a significant burden of cost and time and requires human penetration testers. Thus, a technique for executing cyber-attack simulation for systems automatically is desired.

While a technique of executing a penetration test automatically has been conventionally known, it has however difficulties in planning, analyzing and controlling the penetration test to increase a final attack success probability.

### BRIEF DESCRIPTION OF THE DRAWINGS

FIG. 1 is a flowchart illustrating the flow of an automated test control suites;

FIG. 2 is a diagram illustrating an example of the functional configuration of a control apparatus with automated test suites according to a first embodiment;

FIG. 3 is a diagram for explaining capabilities in the first embodiment;

FIG. 4 is a flowchart illustrating an example of an automated test control method in the first embodiment;

FIG. 5 is a diagram illustrating an example of the functional configuration of an analyzer in the first embodiment;

FIG. 6 is a diagram illustrating an example of the functional configuration of an organizer in the first embodiment;

FIG. 7 is a diagram illustrating an example of the functional configuration of an executor in the first embodiment;

FIG. 8 is a flowchart illustrating an example of processing of an attack step information updater in the first embodiment;

FIG. 9A is a flowchart illustrating an example of an automated test control method according to a second embodiment;

FIG. 9B is the flowchart illustrating subsequent processes of an automated test control method in the second embodiment;

FIG. 10 is a diagram illustrating an example of the functional configuration of an organizer in the second embodiment;

FIG. 11 is a diagram illustrating an example of the hardware configuration of a control apparatus with automated test suites in the first and second embodiments.

### DETAILED DESCRIPTION

A control apparatus with automated test suites according to an embodiment includes capability information storage, and at least one hardware processor configured to function as an analyzer, an organizer, and an executor. The capability information storage stores therein a plurality of capabilities defining actions indicating attack methods. The analyzer parses at least one set of network structure information of a system under test and one set of vulnerability information of the system under test. From the vulnerability information, a set of capabilities and related actions are extracted. The organizer generates an attack path through which an achieved state of an attack goal is reached by combining the actions extracted by the analyzer. The executor executes the actions included in the attack path. Hereinafter, embodiments of the control apparatus with automated test suites and a computer program will be described in detail with reference to the accompanying drawings.

First, flow of an automated test control suites is described.

Flow of an Automated Test Control Suites

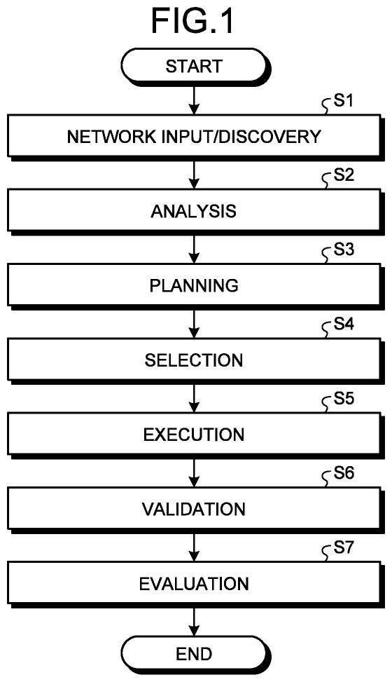

FIG. 1 is a flowchart illustrating the flow of an automated test control suites.

First, the control apparatus with automated test suites reads a network configuration (step S1). To be specific, the control apparatus with automated test suites acquires network structure information, vulnerability information, and the like of a system under test. An automated penetration test when performed with the knowledge of the specification of a system under test is called as white box test. An automated penetration test when performed without the knowledge of any specification of a system under test is called as black box test. In a white box test, the control apparatus with automated test suites acquires information of the whole system under test in advance. In a black box test, the control apparatus with automated test suites executes reconnaissance during the test to acquire partial information or full information of the system under test, where necessary. In addition, these services and vulnerabilities may be exploited and traverse the system to gain further knowledge.

The processing at step S1 is performed in such a manner that the control apparatus with automated test suites calls other tools and acquires output of the other tools, for example. Examples of the other tools include a vulnerability scanner and a network exploration tool.

Then, the control apparatus with automated test suites analyzes information acquired by the processing at step S1 (step S2). To be specific, the control apparatus with automated test suites converts the format of the pieces of information acquired by the processing at step S1 into the format of the pieces of information that is used by the control apparatus with automated test suites because the format of the pieces of information acquired by the processing at step S1 is not necessarily the format that is used by the control apparatus with automated test suites. The control apparatus with automated test suites associates the pieces of information acquired by the processing at step S1 with pieces of information that are used for attack path planning processing executed at step S3 and attack execution processing executed at step S5.

Subsequently, the control apparatus with automated test suites plans attack paths (step S3). To be specific, the control apparatus with automated test suites plans a plurality of sequence of actions (attack paths) through which an achieved state of an attack goal of an attacker is reached from an initial state thereof based on the initial state and the attack goal. The attacker is a terminal that is used for attack and is, for example, the control apparatus with automated test suites, a terminal exploited by the control apparatus with automated test suites, or the like. The control apparatus with automated test suites assigns scores (for example, float values) indicating priorities to the respective attack paths such that an attack path can be selected in attack path selection processing executed at step S4.

Then, the control apparatus with automated test suites selects an attack path with the highest priority from the attack paths planned at step S3 (step S4).

Thereafter, the control apparatus with automated test suites executes actions (attack steps) included in the attack path (step S5). To be specific, the control apparatus with automated test suites, for example, calls another tool, causes the tool to execute attack, and acquires an action execution log of another tool. Examples of another tool include an Exploit execution tool.

Then, the control apparatus with automated test suites validates the attack executed at step S5 (step S6). To be specific, the control apparatus with automated test suites determines whether the actions have been successfully executed by referring to the action execution log of another tool, for example.

The control apparatus with automated test suites then evaluates the attack with the attack path selected by the processing at step S4 (step S7). To be specific, the control apparatus with automated test suites stores information acquired by the executed actions based on validation executed at step S6. The control apparatus with automated test suites generates a report including the executed actions and success or failure thereof when execution of the test is completed.

### First Embodiment

In the white box test using an automated test suites, all necessary information is known prior to executing the test and this is sufficient information for performing the test. Even though useful information is known, if attack steps are chosen without any intelligent selection, it is likely that many attacks may not be successful. In order to cope with such a case, a method of reselecting actions and a method of utilizing information that are acquired after the execution of actions are critical.

In the first embodiment, a control apparatus with automated test suites to execute the white box test is described. A control apparatus with automated test suites to execute the black box test in which pieces of information about devices are not known in advance will be described in a second embodiment.

### Example of Functional Configuration

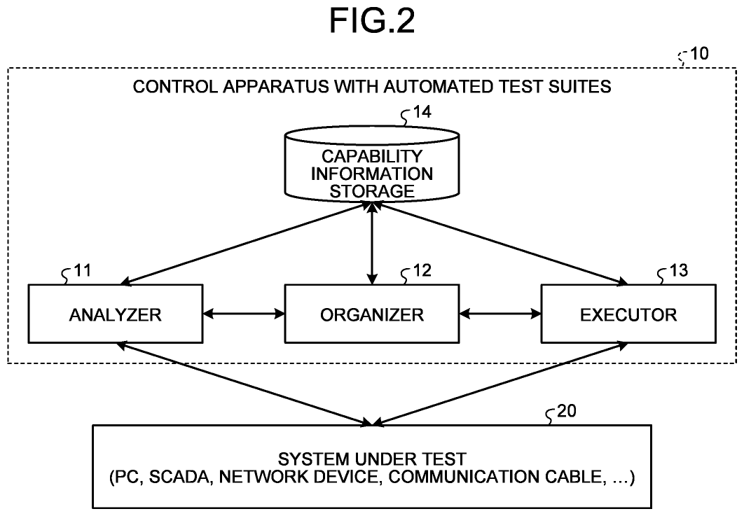

FIG. 2 is a diagram illustrating an example of the functional configuration (framework) of a control apparatus with automated test suites 10 in the first embodiment. The control apparatus with automated test suites 10 in the first embodiment includes an analyzer 11, an organizer 12, an executor 13, and capability information storage 14.

The control apparatus with automated test suites 10 and a system under test 20 are connected to each other such that data and signals can be transferred there between via a cable or radio line.

The control apparatus with automated test suites 10 automatically executes the test on the system under test 20.

The system under test 20 is an information processing system and an automated test execution target. The system under test 20 is a typical Industrial Control System (ICS) configured by, for example, devices such as a PC (Personal Computer), an HMI (Human Machine Interface), an SCADA (Supervisory Control And Data Acquisition), an OPC (OLE for Process Control) server, an EWS (Engineering Workstation), a PLC (Programmable Logic Controller), a router, a switching hub, and a repeater.

The analyzer 11 analyzes at least one of the network structure information of the system under test 20 and the vulnerability information of the system under test 20 to analyze information that the control apparatus with automated test suites 10 can use. The analyzer 11 executes the analysis processing at step S2 in the above-mentioned flow of the automated test suites (see FIG. 1). The analyzer 11 extracts actions (attack steps) to be taken on the system under test 20 from capabilities stored in the capability information storage 14. The capability contains information defining an action (attack step). The capability defines the action (attack step) in such a format that a specific host, network, or the like are not specified. The specific host, network, or the like is specified by setting unspecified parameters from state information. The analyzer 11 inputs an analysis result to the organizer 12.

The organizer 12 generates attack paths through which an achieved state of an attack goal is reached by combining the actions extracted by the analyzer 11. To be specific, the organizer 12 determines the actions (attack steps) that the executor 13 executes based on the analysis result received from the analyzer 11. The organizer 12 determines whether execution of the test is completed and then generates a test execution report. The organizer 12 executes the attack path planning processing at step S3, the attack path selection processing at step S4, the validation processing at step S6, and the evaluation processing at step S7 in the above- mentioned automated test flow (see FIG. 1).

The executor 13 executes the actions (attack steps) included in the attack path generated by the organizer 12. The executor 13 transfers, to the organizer 12, a result generated in the execution of the actions (attack steps). The executor 13 executes the attack execution processing at step S5 in the above-mentioned automated test flow (see FIG. 1).

The capability information storage 14 stores therein the capabilities defining the actions indicated by attack steps. The capabilities are used when the analyzer 11, the organizer 12, and the executor 13 refer to pieces of information related to the actions (attack steps).

Next, an example of a capability expressing method is described. The capabilities associate pre-conditions, actions, and post-conditions with one another. The analyzer 11 extracts actions satisfying the pre-condition from the capabilities. The organizer 12 generates the attack path based on the pre-condition and the post-condition.

Example of Capability

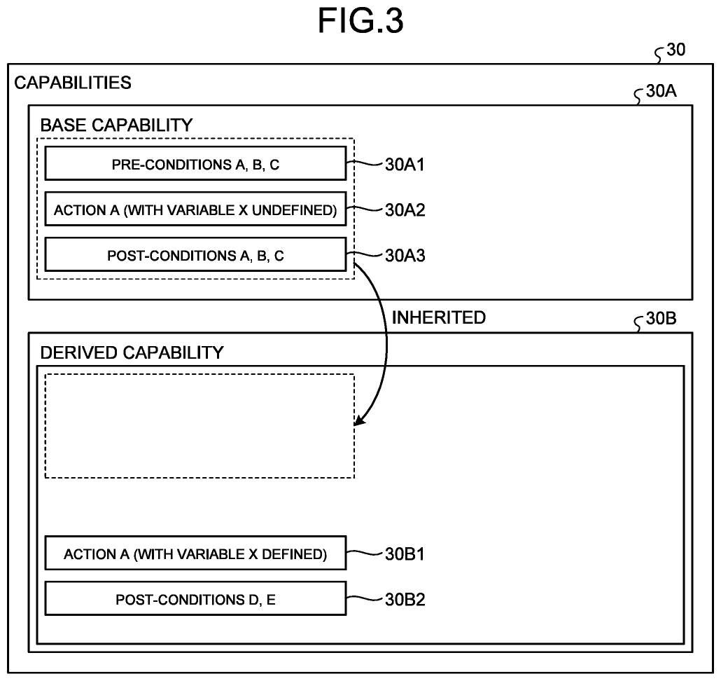

FIG. 3 is a diagram for explaining capabilities 30 in the first embodiment. As illustrated in FIG. 3, the capabilities 30 include a base capability 30A and a derived capability 30B. Although there may be a plurality of base and derived capabilities, FIG. 3 illustrates only a single instance of the base capability 30A and the derived capability 30B.

The base capability 30A includes a pre-condition 30A1, an action 30A2, and a post-condition 30A3. The derived capability 30B includes an action 30B1 and a post-condition 30B2.

The pre-condition 30A1 includes one or more conditions that are required to be present for the action to be executed. The pre-condition 30A1 includes, for example, the condition that an attacker has shell access on the current host. The pre-condition 30A1 includes, for example, the condition that an unexploited host runs a service on a specified port.

An action is an intrusion activity, operation, or the like to the system under test 20, which is performed in an automated test suites. An action is, for example, an intrusion activity that the control apparatus with automated test suites 10 performs to intrude into an unexploited remote host from an exploited host by taking advantage of a vulnerability of the remote host and acquires authority of operating a shell. Alternatively, the action is, for example, an operation of logging in a service (as an example, Telnet, FTP, RDP, RSH, and SSH) that an unexploited host provides by using known authentication information (credential). Furthermore, the action is, for example, an operation of transmitting an instruction to perform an unauthorized remote operation to a host that provides a service of performing a remote control operation of a device.

The post-condition includes one or more conditions that are satisfied when an action is normally executed. Examples of the post-condition include the condition that an unexploited host becomes an exploited host.

Each of the pre-condition, the action, and the post-condition may be configured by a plurality of items. In FIG. 3, the pre-condition 30A1 includes, for example, a pre-condition A, a pre-condition B, and a pre-condition C.

As illustrated in FIG. 3, a capability is either a ‘base capability’ or a ‘derived capability’.

The base capability describes all or a part of the pre-condition, the action, and the post-condition that a plurality of derived capabilities may inherit. In FIG. 3, the base capability 30A includes the pre-condition 30A1, the action 30A2, and the post-condition 30A3. The action 30A2 is described using a variable (parameter) X but a value of the variable X is not defined. When the variable X is a variable indicating an address or the like specifying a host, for example, a specific value indicating a specified host is not set to the variable X in the base capability 30A. The value for the parameter X is determined when the organizer attempts to determine attack paths.

A derived capability describes the pre-condition, the action, and the post-condition that are added to or overwrite contents inherited from the base capability. In FIG. 3, the derived capability 30B describes the action 30B1 and the post-condition 30B2 while inherited from the base capability 30A. The action 30B1 redefines the variable X and overwrites the contents of the action 30A2 inherited from the base capability 30A. The post-condition 30B2 describes a post-condition D and a post-condition E that are not described in the base capability 30A. In the derived capability 30B, the post-conditions D and E are thus added to the post-condition 30A3 inherited from the base capability 30A.

Usage of the two types of capabilities including the base capability and the derived capability enables a plurality of derived capabilities to share the same base capability, thereby reducing the amount of described contents of the capabilities 30 overall.

A set of initial conditions and a final goal condition are input as parameters to the system. During execution, the system determines if the final goal condition can be met. The control apparatus with automated test suites 10 determines whether it is possible to perform a specified operation on the system under test 20, such as changing the temperature on a PLC unit. To determine attack paths, the test suite and a control apparatus 10 uses the set of pre-conditions, actions and post conditions defined as capability information 30 to determine transitions by performing attack steps. Each step advances closer to the goal. This procedure is repeated until the final completion goal is obtained. The organizer 12 determines a set of attack paths that can reach the specified goal.

The capabilities 30 are described using eXtensible Markup Language (XML), as an example. In the capabilities 30 are described in a manner that is independent from any specific network or host layout by using variable names X as placeholders. The variables get filled in when running the tool against a system under test 20.

### Example of Automated Test Control Method

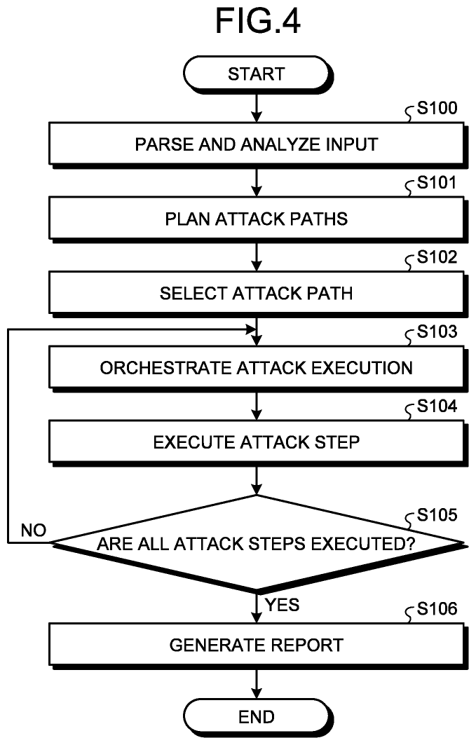

FIG. 4 is a flowchart illustrating an example of the automated test control method in the first embodiment. FIG. 4 illustrates the flowchart in the case of the white box test.

First, the analyzer 11 in the first embodiment parses and analyzes pieces of information (network structure, vulnerability information, and the like) input to the analyzer 11 (step S100). To be specific, the analyzer 11 organizes the pieces of input information (converts to a common information format), specifies capabilities related to the pieces of input information, and so on. For example, when the input information includes a port number, the analyzer 11 specifies a capability using the port number.

Then, the organizer 12 plans attack paths through which an achieved state of an attack goal of an attacker is reached from an initial state thereof based on the pieces of information analyzed in the processing at step S1 (step S101).

Thereafter, the organizer 12 selects an attack path with a high priority from the attack paths by using scores (step S102). Details of the scores will be described later.

The organizer 12 then extracts an attack step executed next based on the selected attack path and an execution status of the current attack step (step S103).

Subsequently, the executor 13 executes the extracted attack step (step S104).

Then, the organizer 12 determines whether all the attack steps on the attack path have been executed and the attack goal of the attacker has been reached (step S105). When the attack goal of the attacker has been reached (Yes at step S105), the organizer 12 generates a report stating a summary of execution, success or fail, details of the results and the like of the attack steps and finishes the processing (step S106). When the attack goal of the attacker has not been reached (No at step S105), the processing returns to step S103.

Next, details of the functional configurations of the analyzer 11, the organizer 12, and the executor 13 will be described.

### Example of Functional Configuration of Analyzer

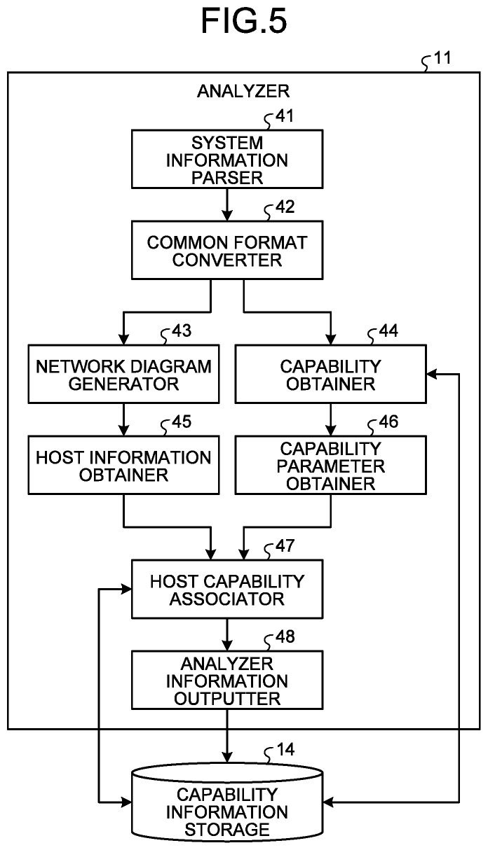

FIG. 5 is a diagram illustrating an example of the functional configuration of the analyzer 11 in the first embodiment. The analyzer 11 includes a system information parser 41, a common format converter 42, a network diagram generator 43, a capability obtainer 44, a host information obtainer 45, a capability parameter obtainer 46, a host capability associator 47, and an analyzer information outputter 48.

The system information parser 41 acquires pieces of information of the system under test 20 (pieces of information of services that are provided by the respective devices, pieces of information of vulnerabilities that are included in the respective devices, pieces of network setting information of the respective devices, and the like). The pieces of information of the services that are provided by the respective devices include, for example, operating systems, applications, and port numbers. The pieces of information of the vulnerabilities that are included in the respective devices include CVE (common vulnerabilities and exposures) numbers. The pieces of network setting information of the respective devices include, for example, IP addresses, MAC addresses, and sub networks of hosts.

The system information parser 41 may acquire the pieces of information of the system under test 20 from results of vulnerability scan on all the devices included in the system under test 20, for example. Alternatively, the system information parser 41 may acquire the pieces of information of the system under test 20 by reading a file stating pieces of installed software, pieces of network structure information, pieces of configuration setting information, and the like of all the devices included in the system under test 20, for example. Furthermore, the system information parser 41 may acquire pieces of information of vulnerabilities for the pieces of installed software of all the devices included in the system under test 20 from a vulnerability database.

The common format converter 42 converts the pieces of information acquired by the system information parser 41 into a common format as a format that is used in the control apparatus with automated test suites. The common format includes host information (host name, IP address, or the like), operating service information (open port number, protocol, or the like), and vulnerability information (identifier indicating a specified vulnerability (for example, CVE number), or the like).

The network diagram generator 43 analyzes connection relations among the devices based on the pieces of network setting information acquired by the system information parser 41. The network diagram generator 43, for example, determines that a device group belonging to the same subnet belongs to the same network and is accessible to one another. The network diagram generator 43 then uses the network information collected to create a visual depiction of the network in the system under test 20.

The capability obtainer 44 extracts capabilities including actions satisfying the pre-condition from the capabilities. To be specific, the capability obtainer 44 extracts the capabilities stored in the capability information storage 14 based on the pieces of information of the services that are provided by the respective devices, the pieces of information of the vulnerabilities that are included in the respective devices, and the like, the pieces of information having been acquired by the system information parser 41. The capability obtainer 44, for example, checks whether each of the pre-conditions of the capabilities stored in the capability information storage 14 includes any of the conditions related to the services, the vulnerabilities, and the like specified by the system information parser 41. The capability obtainer 44 extracts the capabilities including, as the pre-conditions, the conditions related to any of the services, the vulnerabilities, or the like mentioned above.

The host information obtainer 45 generates a list of the devices based on the pieces of network setting information acquired by the system information parser 41. The host information obtainer 45, for example, extracts pieces of information (for example, a host name or an IP address) specifying devices and combines them with unique identifiers. The host information obtainer 45 gives an identifier to a device belonging to a plurality of networks and having a plurality of assigned IP addresses such that the device is regarded as one device.

The capability parameter obtainer 46 sets specific values of variables (parameters) included in the capabilities extracted by the capability obtainer 44. To be specific, the capability parameter obtainer 46 obtains the values to be set to the parameters included in the capabilities extracted by the capability obtainer 44 from at least one of the network structure information and the vulnerability information. The capability parameter obtainer 46, for example, sets, to the parameters included in the capabilities, the IP addresses or the like identifying the hosts providing the services based on which the capability obtainer 44 has extracted the capabilities and that have been specified by the system information parser 41.

The host capability associator 47 associates the capabilities including the parameters to which the specific values (for example, IP addresses) have been set with the pieces of host information (host names, IP addresses, or the like).

The analyzer information outputter 48 outputs, to the organizer 12, the capabilities that the host capability associator 47 has associated with the pieces of host information.

### Example of Functional Configuration of Organizer

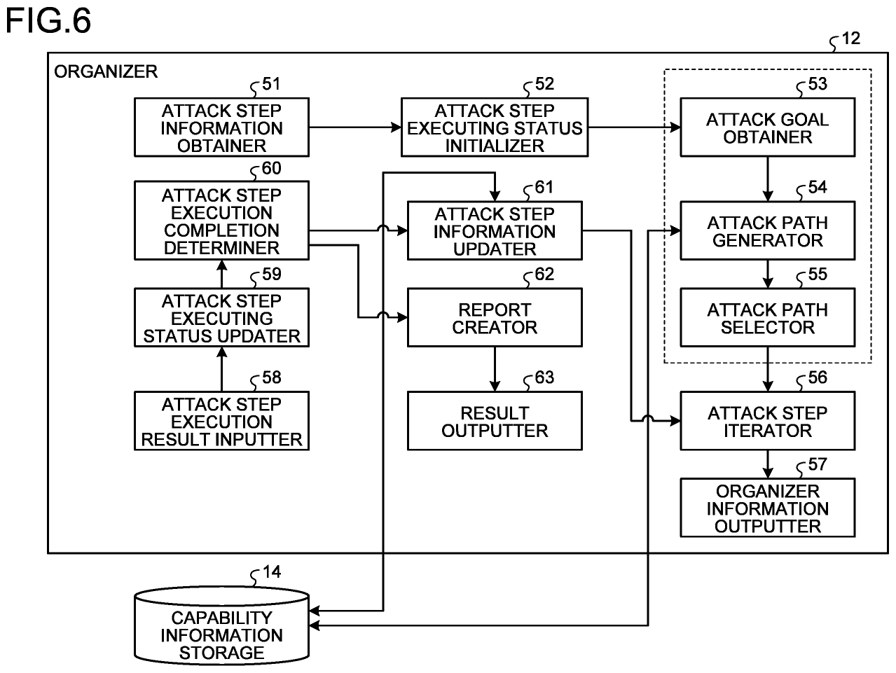

FIG. 6 is a diagram illustrating an example of the functional configuration of the organizer 12 in the first embodiment. The organizer 12 in the first embodiment includes an attack step information obtainer 51, an attack step executing status initializer 52, an attack goal obtainer 53, an attack path generator 54, an attack path selector 55, an attack step iterator 56, an organizer information outputter 57, an attack step execution result inputter 58, an attack step executing status updater 59, an attack step execution completion determiner 60, an attack step information updater 61, a report creator 62, and a result outputter 63.

The attack step information obtainer 51 obtains the capabilities output from the analyzer 11.

The attack step executing status initializer 52 sets the initial state of the attack steps. The initial state includes information specifying access to a target device, authority information regarding access to a target device, and information indicating whether a specific action has been executed. The accessible authority information is authority information indicating whether a shell operation can be performed with organizer authority, for example.

The attack step executing status initializer 52 sets the device to be accessed by the control apparatus with automated test suites 10 to only a device capable of being accessed in an initial state. The attack step executing status initializer 52 sets the accessible authority information to authority information accessible in the initial state. The attack step executing status initializer 52 sets all the actions to be in non-executed status.

The attack goal obtainer 53 obtains, from a user, a device into which the control apparatus with automated test suites 10 tries to intrude finally and input indicating the status of the device, and sets an attack goal. For example, the attack goal obtainer 53 sets, as the attack goal, unauthorized rewriting of a value of a register that a control device included in the system under test 20 holds. Alternatively, the attack goal obtainer 53 sets, as the attack goal, unauthorized acquisition of authentication information stored in a database server included in the system under test 20, for example. Furthermore, in the single host use case, rather than try to reach a single attack goal, the system will attempt to exploit all vulnerabilities on the specified host.

The attack path generator 54 accepts as input a set of the initial conditions and a final goal provided by the attack goal obtainer 53. The attack path generator 54 uses the set of initial conditions to set an internal initial state, and the final goal as a terminal condition. By using the internal knowledge database comprising capability information and network and host information, it generates one or more attack paths that satisfy the attack step information obtainer 51. When no attack path satisfying the conditions is found, the attack path generator 54 outputs an error that there is no attack path satisfying the conditions and finishes the processing.

All the actions having the specified parameters in the attack path differ from one another. In the case of a test on the entire system including a plurality of hosts, when attack exploits the same vulnerability by the same action in two attack paths, target hosts thereof may differ from each other. In the case of the single-host test targeted on one host, two actions in the attack path are attacks exploiting vulnerabilities differing from each other.

A special reset action of canceling the effects of actions executed before the action may be set as an action in the attack path. This reset action can eliminate the failure that the system becomes unstable due to the attack and subsequent actions cannot be executed. For example, when the effect of the action is excess communication load caused by Dos (Denial of Service Attack) attack or the like, the special reset action stops the Dos attack.

When the attack path generator 54 outputs a plurality of attack paths, the attack path selector 55 selects an attack path with a high priority from the attack paths. The priority is determined by, for example, a score calculated by the weighted total sum of shortness of an attack path (smallness of the number of actions), reliability of the actions, the degree of difficulty in detection that the action is unauthorized, lowness of the total number of potential capabilities included in the hosts on a route along the attack path, and the like.

The attack step iterator 56 selects, as attack steps, actions included in the attack path selected by the attack path selector 55 in order. The attack step iterator 56 selects an action subsequent to an executed action at the deepest site on the attack path. Information indicating whether the action has been executed can be acquired from the attack step executing status.

When the selected attack step is determined to be inappropriate, the attack step iterator 56 may exclude the selected attack path, and then, cause the attack path selector 55 to select another attack path. When the selected attack step is determined to be “attack failed” from the attack step executing status, for example, the attack step iterator 56 may cause the attack path selector 55 to select another attack path.

The organizer information outputter 57 outputs the action (attack step) selected by the attack step iterator 56. The executor 13 executes the action (attack step) output from the organizer information outputter 57.

The attack step execution result inputter 58 acquires an attack step execution result output from the executor 13. The attack step execution result includes a log output when the attack step is executed and the log includes information that is used for determination of success or failure of the attack step.

The attack step executing status updater 59 updates the attack step executing status. When it can be determined that the attack step has been successfully executed from the attack step execution result, for example, the attack step executing status updater 59 updates the executed attack step to “executed”. When an attack step has been successfully executed and the attacker has gained access to a new host, the attack step executing status updater 59 adds the host to the list of devices accessible by the attacker. When it is determined that the attack step has failed from the attack step execution result, for example, the attack step executing status updater 59 updates the executing status of the executed attack step to “failed”.

The attack step execution completion determiner 60 determines whether calling of the executor 13 is finished. When the termination condition of the capability corresponding to the executed attack step includes the condition of the attack goal acquired by the attack goal obtainer 53, for example, the attack step execution completion determiner 60 finishes the calling of the executor 13. When the calling of the executor 13 is not finished, the attack step execution completion determiner 60 calls the attack step information updater 61 whereas when the calling of the executor 13 is finished, it calls the report creator 62.

The attack step information updater 61 updates the capability corresponding to the attack step. The attack step information updater 61 sets the priority of the attack path including the action corresponding to the attack step for which execution has failed to be lower than the priorities of attack paths including no action corresponding to the attack step for which execution has failed, for example. To be specific, the attack step information updater 61, for example, sets such that a low score is assigned to an attack step giving large influences on a host as an execution target of the attack step for which the attack step executing status updater 59 has updated to “attack failed” in an attack step group targeted on the host. Attack steps here are, for example, steps that generate a significant amount of packets or cause an unauthorized file to execute.

The report creator 62 generates a test report related to the executed attack step. The report creator 62 generates, for example, a report including success or failure of the executed attack step (action), the attack path including the executed attack step, and a security countermeasure plan (security countermeasure plan based on the action execution result) of the system under test that is determined from the successfully executed attack step.

The result outputter 63 displays the report generated by the report creator 62, a network diagram of the system under test 20, and the like.

### Example of Functional Configuration of Executor

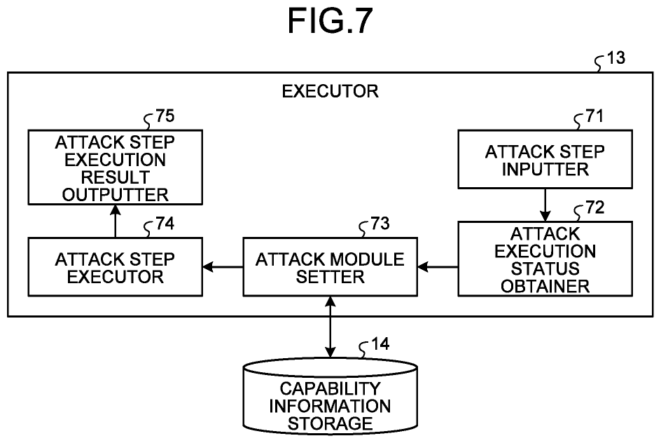

FIG. 7 is a diagram illustrating an example of the functional configuration of the executor 13 in the first embodiment. The executor 13 in the first embodiment includes an attack step inputter 71, an attack execution status obtainer 72, an attack module setter 73, an attack step executor 74, and an attack step execution result outputter 75.

The attack step inputter 71 acquires the attack step output from the organizer 12.

The attack execution status obtainer 72 obtains an attack execution status. The attack execution status contains attack step execution history indicating whether a specified host has been exploited. After a host has been successfully exploited, a connection is retained to that host in order to perform additional attack steps, for example, to further targets that are reachable via the exploited hosts. The attack execution status obtainer 72 can utilize the intrusion port generated in the past by acquiring the attack execution status.

The attack module setter 73 sets various parameters of an attack tool based on the capability. An attack tool is a software executing each attack step. The attack module setter 73 verifies whether parameter information necessary for executing the attack step in the information acquired by the attack step inputter 71 is sufficient. If additional parameter information is required to perform an attack step, the attack module setter 73 acquires additional details from capability information storage 14. When the information acquired by the attack step inputter 71 is an ID identifying the capability, for example, the attack module setter 73 acquires, from the capability information storage 14, information of the capability identified by the ID.

The attack step executor 74 instructs the software executing the attack step to execute the attack step and acquires an attack step execution result.

The attack step execution result outputter 75 outputs the attack step execution result.

Next, details of the processing of the attack step information updater 61 in the first embodiment are described.

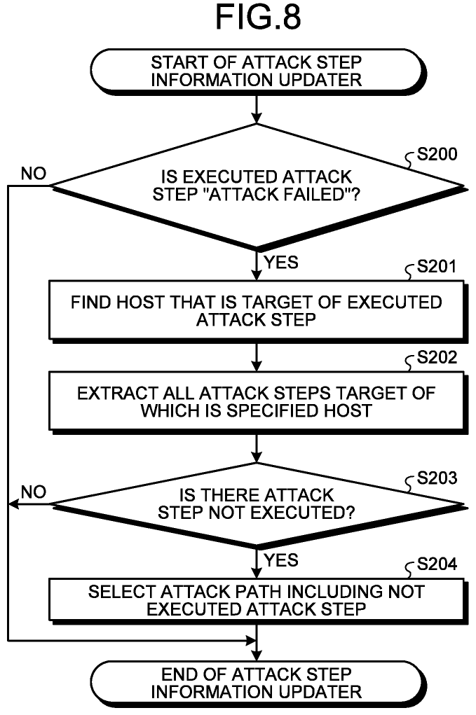

FIG. 8 is a flowchart illustrating an example of the processing of the attack step information updater 61 in the first embodiment. First, the attack step information updater 61 determines whether the executed attack step has been updated to “attack failed” (step S200). When the executed attack step has not been updated to “attack failed” (No at step S200), the processing of the attack step information updater 61 is finished.

When the executed attack step has been updated to “attack failed” (Yes at step S200), the attack step information updater 61 specifies (finds) a host as the execution target of the executed attack step by referring to the capabilities output by the analyzer 11 (step S201).

Then, the attack step information updater 61 extracts the entire attack step group targeted on the host specified by the processing at step S201 by referring to the capabilities output by the analyzer 11 (step S202).

Subsequently, the attack step information updater 61 determines whether there is an attack step that is not executed (step S203). When there is no attack step that is not executed (No at step S203), the processing of the attack step information updater 61 is finished.

When there is an attack step that is not executed (Yes at step S203), the attack step information updater 61 selects an attack path including the attack step that is not executed, and updates the attack step information such that the attack step in the selected attack path is executed in subsequent attack step execution (step S204).

As described above, in the control apparatus with automated test suites 10 in the first embodiment, the capability information storage 14 stores therein the capabilities defining the actions indicating the attack methods. The analyzer 11 parses at least one of the network structure information of the system under test 20 and the vulnerability information of the system under test 20 to extract the actions from the capabilities. The organizer 12 combines the actions extracted by the analyzer 11 to generate the attack paths through which the achieved state of the attack goal is reached. The executor 13 executes the actions included in the attack path.

The control apparatus with automated test suites 10 in the first embodiment can therefore assist during a test to increase the likelihood of final attack success.

### Second Embodiment

Next, a second embodiment is described. In description of the second embodiment, similar description to that in the first embodiment is omitted and differences from the first embodiment are described.

In the black box test in which only a part of information necessary for creating an attack plan is known in advance, sufficient information is not available to perform an intrusion to the final destination. In the second embodiment, a method enabling actions having high certainties executed using information acquired after execution of actions is described.

### Example of an Automated Test Control Method

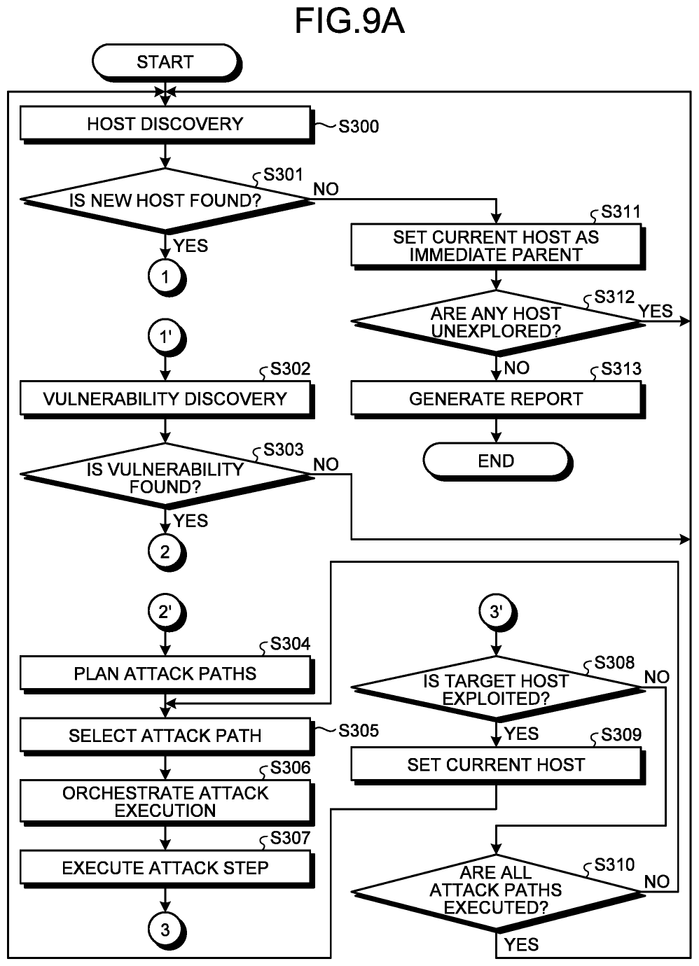

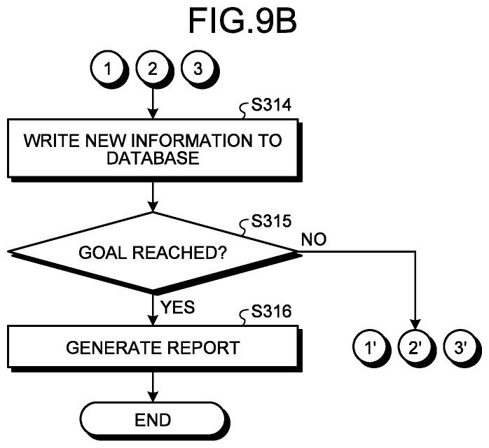

FIGS. 9A and 9B are flowcharts illustrating an example of an automated test control method in the second embodiment. FIGS. 9A and 9B illustrate the flowcharts in the case of the black box test.

First, the organizer 12 explores a host as an access target from a current host position (step S300). In the flowchart, an attacker explores for a new host by a depth-first search. The found host is managed by a tree structure in which an attacker in an initial state (attack start time) is a root.

Then, the organizer 12 determines whether a new host on which processing has not been performed has been found by the host discovery processing at step S300 (step S301).

When New Host Has Been Found

When the new host has been found (Yes at step S301), the processing proceeds to step S314 in FIG. 9B. Flow in FIG. 9B will be described later.

After the pieces of processing in the flow in FIG. 9B are executed, the organizer 12 checks whether the new host found by the host discovery at step S300 has a vulnerability in any of services, applications, generation of communication, and the like (step S302). When the new host has no vulnerability at all (No at step S303), the processing returns to step S300.

When the new host has one or more vulnerabilities (Yes at step S303), the processing proceeds to step S314 in FIG. 9B. The flow in FIG. 9B will be described later.

After the pieces of processing in the flow in FIG. 9B are executed, the organizer 12 explores for attack paths through which the newly found host is attacked based on pieces of information found by the host discovery, the vulnerability discovery, and the like (step S304).

Thereafter, the organizer 12 selects an attack path with a high priority from the attack paths by using scores (step S305).

The organizer 12 then orchestrates an attack step executed next based on the selected attack path and the execution status of the current attack step (step S306).

Subsequently, the executor 13 executes the attack step extracted by the processing at step S306 (step S307). Then, the processing proceeds to step S314 in FIG. 9B. The flow in FIG. 9B will be described later.

After the pieces of processing in the flow in FIG. 9B are executed, the organizer 12 determines whether the attack target host can have been exploited by checking the attack execution log of the executor 13 (step S308). When the target host can be exploited (Yes at step S308), the organizer 12 sets the target host to the current host position and returns to step S300 (step S309).

When the target host cannot be exploited (No at step S308), the organizer 12 determines whether all the attack paths have been executed (step S310). When all the attack paths have not been executed (No at step S301), the processing returns to step S305. When all the attack paths have been executed (Yes at step S301), the processing returns to step S300 in order to explore for another new host.

When No New Host Has Been Found

When it is determined that no new host has been found (No at step S301), the organizer 12 sets the current host position as a parent node of the current host (step S311). The parent node is a host corresponding to a node of a parent of the current host in the above-mentioned tree structure.

The organizer 12 determines whether there is any host that can be explored from the current host set at step S311 (step S312). When there is an unexplored host (Yes at step S312), the processing returns to step S300. When there is no unexplored host (No at step S312), the organizer 12 generates a report stating execution results and success or failure of the attack steps and finishes the processing (step S313).

Next, the flow in FIG. 9B is described.

First, the organizer 12 writes, into a database (capability information storage 14), the pieces of information acquired by the host discovery (Yes at step S301), the vulnerability discovery (after execution of the processing at step S302), and the attack step execution (after execution of the processing at step S307) (step S314).

The organizer 12 then determines whether the attack goal of the attacker has been reached (step S315). When the attack goal of the attacker has been reached (Yes at step S315), the organizer 12 generates a report stating execution contents and success or failure of the attack steps and finishes the processing (step S316).

When the attack goal of the attacker has not been reached (No at step S315), the processing returns to the flowchart in FIG. 9A. To be specific, when the flowchart in FIG. 9B is executed after the host discovery (in the case of Yes at step S301), the processing proceeds to step S302 in FIG. 9A. When the flowchart in FIG. 9B is executed after the vulnerability discovery (after execution of the processing at step S302), the processing proceeds to step S304 in FIG. 9A. When the flowchart in FIG. 9B is executed after execution of the attack step execution (after execution of the processing at step S307), the processing proceeds to step S308 in FIG. 9A.

Next, details of the functional configuration of the control apparatus with automated test suites 10 in the second embodiment are described. In the second embodiment, the functional configuration of the organizer 12 differs from that in the first embodiment. The analyzer 11 and the executor 13 are the same as those in the first embodiment and description thereof is therefore omitted.

### Example of Functional Configuration of Organizer

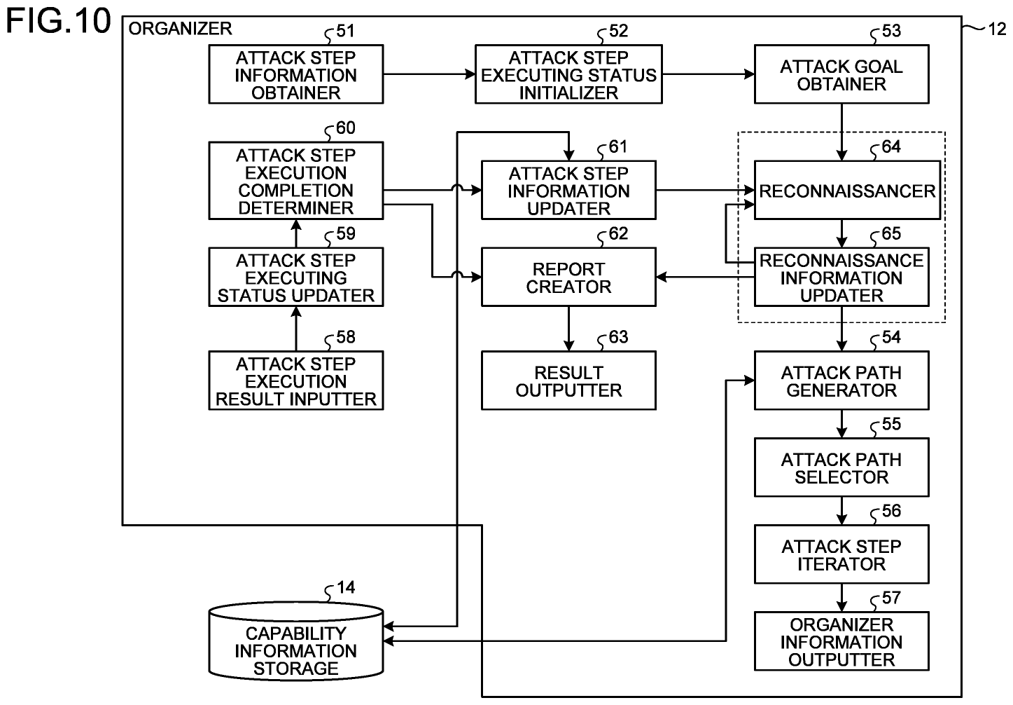

FIG. 10 is a diagram illustrating an example of the functional configuration of the organizer in the second embodiment. The organizer 12 in the second embodiment includes the attack step information obtainer 51, the attack step executing status initializer 52, the attack goal obtainer 53, the attack path generator 54, the attack path selector 55, the attack step iterator 56, the organizer information outputter 57, the attack step execution result inputter 58, the attack step executing status updater 59, the attack step execution completion determiner 60, the attack step information updater 61, the report creator 62, and the result outputter 63. In the second embodiment, a reconnaissancer 64 and a reconnaissance information updater 65 are added to the configuration of the organizer 12 in the first embodiment.

Hereinafter, description of the functions common to those in the first embodiment is omitted.

The attack path generator 54 generates one or more attack paths based on the capabilities acquired by the attack step information obtainer 51 while setting, to the initial condition, access authority to the current host (host that can be exploited by the control apparatus with automated test suites 10) and setting, to the completion condition, a condition necessary for achieving the attack goal. When no attack path satisfying the conditions is found for any combination of the initial condition and the termination condition, the attack path generator 54 outputs an error that there is no attack path satisfying the condition and finishes the processing.

The condition necessary for achieving the attack goal is the condition that becomes possibly necessary for accessing a final attack target host indicated by the attack goal of the attacker. To be specific, the condition necessary for achieving the attack goal is, for example, to acquire access authority to an unexploited host. Furthermore, the condition necessary for achieving the attack goal is, for example, to operate an unexploited host in an unauthorized manner via communication.

The attack step information updater 61 updates information related to a capability (the parameter of which may or may not have been already specified). When attacked by the executed attack step is attack of acquiring authentication information (credential) related to a different host from the host as the attack target, the attack step information updater 61 extracts a capability for logging in the different host using the authentication information from the capability information storage 14 and sets the authentication information to the parameter of the capability.

The attack step information updater 61 may call the functions of the analyzer 11. When the host discovery is performed using a network search tool, for example, the attack step information updater 61 may call the system information parser 41 for parsing, call the common format converter 42 for format conversion, call the network diagram generator 43 for analyzing connection relations among the devices, or call the host information obtainer 45 for creating a device list.

The reconnaissancer 64 determines the necessity of performing additional reconnaissance, and if necessary discovers any previously unknown hosts and services. When all known the execution paths are executed and no new vulnerability is found, the reconnaissancer 64 determines that the reconnaissance is necessary. Reconnaissance attempts to identify at least one new set of network structure information and the vulnerability information. To be specific, the reconnaissance includes host discovery and vulnerability discovery, for example. In the host discovery, for example, the above-mentioned current host transmits a ping command to each of addresses on a subnet and checks hosts that have responded. In the vulnerability discovery, for example, an attacker performs SYN scan on a target host, checks a waiting port for a service, makes vulnerability check communication appropriate for each service, and checks presence of the vulnerability.

The reconnaissance information updater 65 updates information related to the network structure and the capability (the parameter of which may or may not have been already specified) based on the information acquired by the reconnaissance. The reconnaissance information updater 65 adds a newly found host to the network structure when the reconnaissance is the host discovery, for example. The reconnaissance information updater 65 updates the parameter included in any of the capabilities based on at least one of the network structure information and the vulnerability information acquired by the reconnaissance. To be specific, when the reconnaissance is the vulnerability discovery, the reconnaissance information updater 65 extracts a capability related to an attack step using a newly found vulnerability and sets host information or the like to the parameter of the capability. The reconnaissance information updater 65 determines whether the attack goal of the attacker has been achieved by the reconnaissance and calls the report creator 62 when achieved.

As described above, the control apparatus with automated test suites 10 in the second embodiment can provide the same effects as those provided in the first embodiment even when the black box test in which only a part of information necessary for creating the attack plan is known in advance is executed.

Finally, the hardware configuration of the control apparatus with automated test suites 10 in the first and second embodiments is described.

### Example of Hardware Configuration

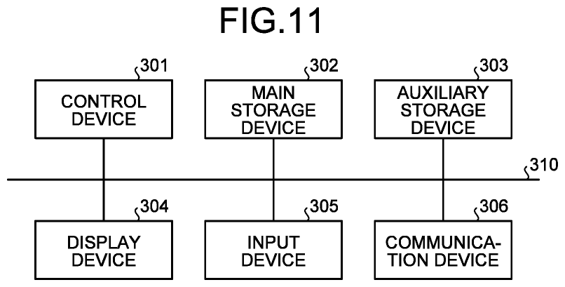

FIG. 11 is a diagram illustrating an example of the hardware configuration of the control apparatus with automated test suites 10 in the first and second embodiments.

The control apparatus with automated test suites 10 includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected to each other via a bus 310.

The control device 301 executes a control program read onto the main storage device 302 from the auxiliary storage device 303. The main storage device 302 is a memory such as a ROM (Read Only Memory) and a RAM (Random Access Memory). The auxiliary storage device 303 is an HDD (Hard Disk Drive), an SSD (Solid State Drive), a memory card, or the like.

The display device 304 displays display information. The display device 304 is, for example, a liquid crystal display. The input device 305 is an interface for operating a computer. The input device 305 is, for example, a keyboard or a mouse. When the computer is a smart device such as a smart phone and a tablet terminal, the display device 304 and the input device 305 are, for example, a touch panel. The communication device 306 is an interface for making communication with other apparatuses.

The computer program that is executed by the computer is recorded and provided as a computer program product in a computer-readable recording medium such as a compact disc read only memory (CD-ROM), a memory card, a compact disc recordable (CD-R), and a digital versatile disc (DVD), as an installable or executable file.

The computer program that is executed by the computer may be stored in a computer connected to a network such as the Internet and provided by being downloaded via the network. Furthermore, the computer program that is executed by the computer may be provided or distributed via a network such as the Internet.

The computer program that is executed by the computer may be embedded and provided in a ROM, for example.

The computer program that is executed by the computer has a module configuration including function blocks executable by the computer program in the functional configuration (function blocks) of the above-mentioned control apparatus with automated test suites 10. The functional blocks are loaded on the main storage device 302 as actual hardware when the control device 301 reads the computer program from the storage medium and executes it. That is to say, the function blocks are generated on the main storage device 302.

Some or all of the above-mentioned function blocks may not be implemented by software but may be implemented by hardware such as an IC (integrated circuit).

When the functions are implemented by using a plurality of processors, the processors may implement one of the functions or implement two or more of them.

Any operation form of the computer implementing the control apparatus with automated test suites 10 may be adopted. The control apparatus with automated test suites 10 may be implemented by one computer, for example. Alternatively, the control apparatus with automated test suites 10 may be operated as a cloud system on a network, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus with automated test suites comprising:
capability information storage that stores therein a plurality of capabilities defining actions indicating attack methods; and
at least one hardware processor coupled to a memory and configured to function as:
an analyzer that parses at least one of network structure information of a system under test and vulnerability information of the system under test to extract the actions from the capabilities;
an organizer that generates an attack path through which an achieved state of an attack goal is reached by combining the actions extracted by the analyzer; and
an executor that executes the actions included in the attack path.

2. The control apparatus with automated test suites according to claim 1, wherein
each of the actions is defined by being associated with a pre-condition and a post-condition,
the pre-condition includes one or more conditions for executing the action normally,
the post-condition includes one or more conditions that are satisfied when the action is normally executed,
the analyzer extracts the action satisfying the pre-condition from the capabilities, and
the organizer generates the attack path based on the pre-condition and the post-condition.

3. The control apparatus with automated test suites according to claim 2, wherein
the capabilities include a base capability and a derived capability, and
the pre-condition, the action, and the post-condition included in the base capability are inherited by the derived capability.

4. The control apparatus with automated test suites according to claim 2, wherein the analyzer comprises:
a capability obtainer that extracts a capability including the action satisfying the pre-condition from the capabilities; and
a capability parameter obtainer that obtains a value to be set to a parameter included in the capability extracted by the capability parameter obtainer from at least one of the network structure information and the vulnerability information and sets the value to the parameter.

5. The control apparatus with automated test suites according to claim 1, wherein the organizer comprises:
an attack path generator that determines a plurality of attack paths, given an initial set of conditions and a final goal condition, and
an attack path selector that selects, when a plurality of attack paths are generated, an attack path with a high priority from the plurality of attack paths.

6. The control apparatus with automated test suites according to claim 5, wherein the organizer further comprises:
an attack step iterator that selects, as an attack step, an action included in the attack path selected by the attack path selector in order, and
an attack step information updater that sets a priority of an attack path including an action corresponding to an attack step for which execution fails to be lower than a priority of an attack path not including the action corresponding to the attack step for which the execution fails.

7. The control apparatus with automated test suites according to claim 1, wherein the organizer comprises:
a reconnaissancer that executes reconnaissance by acquiring at least one of the network structure information and the vulnerability information; and
a reconnaissance information updater that updates a parameter included in any of the capabilities based on at least one of the network structure information and the vulnerability information acquired by the reconnaissance.

8. The control apparatus with automated test suites according to claim 1, wherein the organizer comprises a report creator that generates a report including success or failure of the executed action, an attack path including the executed action, and a security countermeasure plan based on an execution result of the action.

9. A computer program product comprising a non-transitory computer-readable medium containing a program executed by a computer storing a plurality of capabilities defining actions indicating attack methods, the program causing the computer to function as:
an analyzer that parses at least one of network structure information of a system under test and vulnerability information of the system under test to extract the actions from the capabilities;
an organizer that generates an attack path through which an achieved state of an attack goal is reached by combining the actions extracted by the analyzer; and
an executor that executes the actions included in the attack path.
